(19) United States
(12) Patent Application Publication
(10) Pub. No.: US 2012/0197755 A1
(43) Pub. Date: Aug. 2, 2012

(54) METHOD AND APPARATUS FOR SHOPPING FASHIONS

(76) Inventor: Tobias Felder, Norcross, GA (US)

(21) Appl. No.: 13/353,294

(22) Filed: Jan. 18, 2012

Related U.S. Application Data
(60) Provisional application No. 61/461,365, filed on Jan. 18, 2011.

(51) Int. Cl. G06Q 30/00

(52) U.S. Cl. 705/26.8; 705/27.2

(57) ABSTRACT

An online shopping tool provides multiple mix and match functionalities to shoppers. Conventional online shopping presents a single option, e.g., showing the item alone or how it looks in an ensemble created by someone else. In the real world, a shopper may want to buy a blouse from designer A, a dress from designer B or all items (i.e., images) from designer A from one or related websites/bricks and mortar stores. The present invention allows the shopper to do all of this online by using a shopper controlled multi-channel scrolling matrix with shopping tools that automatically create mix and match ensembles.

### CROSS-REFERENCE TO RELATED APPLICATIONS

This application claims the benefit of priority of U.S. provisional patent application No. 61/461,365, filed Jan. 18, 2011, the contents of which are herein incorporated by reference.

### BACKGROUND OF THE INVENTION

The present invention relates to shopping methods and apparatus and, more particularly, to an online method and apparatus to shop fashion categories/items (from head to toe) with an automated shopper controlled mix and match functionality.

Current fashion and retail websites force the shopper to view and click through all of the items of interest, typically drilling down to show one item per screen. If multiple items are shown on a single screen, they are typically mix and match items coordinated by the fashion vendor and then uploaded to the internet as a single image that displays in a fixed view with other images on the screen. Often, shoppers may wish to know how a particular top may look on the same page with a particular belt, skirt, pants or shoes, for example, which may appear on the same page or from different menu/tab selection on the site.

As can be seen, there is a need for an improved method and apparatus for online shopping of fashion items that allows the shopper to mix and match various items.

### SUMMARY OF THE INVENTION

In one aspect of the present invention, a computer software product disposed on computer readable media and having computer code adapted to perform the steps of providing a matrix of a plurality of columns and rows on a screen; providing images of grouped fashion items across each row; scrolling each row independently to allow the images of grouped fashion items to appear on the screen; and providing a means for freezing at least one of an entire screen, an entire row, or an individual image in the matrix.

In another aspect of the present invention, a website having a mix and match screen display, the mix and match screen display comprises a plurality of columns and a plurality of rows; a plurality of images disposed at intersections of the plurality of columns and the plurality of rows, wherein the images scroll across the screen display; and one or more selection buttons, wherein the selection buttons are adapted to freeze or select a single image, an entire row, an entire column, or the entire screen, wherein each row includes images of related fashion items, and each column provides a head to toe fashion ensemble.

These and other features, aspects and advantages of the present invention will become better understood with reference to the following drawings, description and claims.

### BRIEF DESCRIPTION OF THE DRAWINGS

FIG. 1 is a screen shot of an online shopping portal offering default mix and match options, according to an exemplary embodiment of the present invention;

FIG. 2 is a screen shot of the online shopping portal of FIG. 1 showing an option where fashion designers are grouped together in silos;

FIG. 3 is a screen shot of the online shopping portal of FIG. 1 showing an option where at least one silo is adapted to display item description or advertising information;

FIG. 4 is a screen shot of the online shopping portal of FIG. 1 showing an option where at least one silo is adapted to display accessory items;

FIG. 5 is a screen shot of the online shopping portal of FIG. 1 showing an option where at least one silo is adapted to display a drop down box for gift buying;

FIG. 6 is a screen shot of the online shopping portal of FIG. 1 showing an option to freeze and reverse the scrolling images one image at a time, as well as an option to change designers;

FIG. 7 is a screen shot of the online shopping portal of FIG. 1 showing a filter menu;

FIG. 8 is a screen shot of the online shopping portal of FIG. 1 showing a last item purchased (LIPs) service option; and

FIG. 9 is a schematic representation of how the LIPs service works in an exemplary embodiment of the present invention;

FIG. 10 is a screen shot of fixed images from a “Girls” tab (this could also be boys, babies, women, men of the like) showing a “Rock This” button;

FIG. 11 is a screen shot showing how the “Rock This” button works when it is pressed/activated; it takes the shopper to the scrolling mix and match matrix where the item being shopped for is in freeze mode allowing the shopper to select, with one click, other fashion categories of coordinating images that are scrolling across the screen;

FIG. 12 is a screen shot of another option of how the “Rock This” button could work when it is pressed/activated, displaying a pick list to choose other fashion categories, while on the same page, to coordinate with the item being shopped for;

FIG. 13 is a schematic representation of how the pick list would work on the same screen of the fashion item being shopped for; and

FIG. 14 is a screen shot of the mix and match tab showing a “Hide” button at each fashion category row/channel. The shopper can hide channels that he/she is not shopping for.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an online shopping tool that may present multiple automated mix and match functionalities. Conventional online shopping presents a single option, e.g., showing the item alone or how it looks in an ensemble created by someone else. In the real world, a shopper may want to buy a blouse from designer A, a dress from designer B or all items (i.e., images) from designer A from one or related websites/bricks and mortar stores. The present invention allows the shopper to do all of this online by using a multi-channel scrolling matrix controlled with shopping tools that create mix and match ensembles.

The present invention may include advanced filters to allow a user to select color, fabric, pattern, season, style, etc., including a Last Item Purchased service (LIPs or known as LIP Service). The present invention may include drop-down boxes on each row where the user can select one or more fashion vendors/brands (e.g., retailer/boutique, designers, wholesalers, drop-shippers, etc.). The present invention may include scroll, click, freeze and roll tools. The scroll tool may allow fashion selections to automatically scroll across the screen. A one click tool may permit the user to click on the item/items they want to shop. The freeze (same as the one click tool) tool may pause/freeze the scrolling of an item, a row or the entire shopping matrix/screen. The roll tool may, by clicking on an item or items a second time, cause the item, row or entire shopping matrix/screen to unfreeze, allowing item or items to scroll again for continued shopping.

With these tools up to six or more ensembles can be built; each channel (row) crosses/intersects with 6 silo's (columns) with one image at each intersection point vertically lined up from head to toe in each silo. This matrix could display up to 70 or more images (approx. 11 channels multiplied by up to 6 or more silos). Shoppers sit back and watch and shop as items queried scroll across the screen. Based upon the shopper's selections (e.g., using the advanced filter and vendor selection tools described below), the scrolling screen displays a fraction of the thousands of items in the database. The scrolling screen is a moving window of images retrieved from a database. So in theory, without any filters, the shopper can sit watch every fashion item in inventory scroll across the screen. The watch and shop technology of the present invention creates a new viewing experience resulting in the ultimate shopping experience.

Shoppers can use advanced filters to choose color/color combinations, fabric, pattern, occasion, style, size, season, LIPs, and the like. Channel drop down boxes may be provided in each row to select different fashion vendors (and/or their brands) to further narrow the selections to meet the shopper's desires. Each channel can be set to the same or different fashion vendor. Retrieved images may automatically scroll in a timed loop together or independently across silos, allowing the shopper to shop by ensemble or by piece. The filters may automatically coordinate the pieces from head to toe by channel number (e.g., blouse or jacket at channel 2, skirt or pants at channel 3, stockings/leggings at channel 4, shoes at channel 5, and the like). In some embodiments, a shopper or site administrator may control or change channel positions. For example, the blouse can be displayed on the bottom channel instead of channel 1 or 2.

Shoppers may be able to freeze the rows or may freeze the particular images. For example, if a shopper likes a particular hat, they may click on that hat image, freezing that image, while the other fashion category options continue to scroll. This may permit the user to choose up to six (for example, depending on the number of silos) hats to compare to the other scrolling categories/items. When a user freezes an item, a unique fashion script signature (similar to a SKU number) may be built for the shopper, resulting in a fashion DNA/genome database designed for marketing purposes.

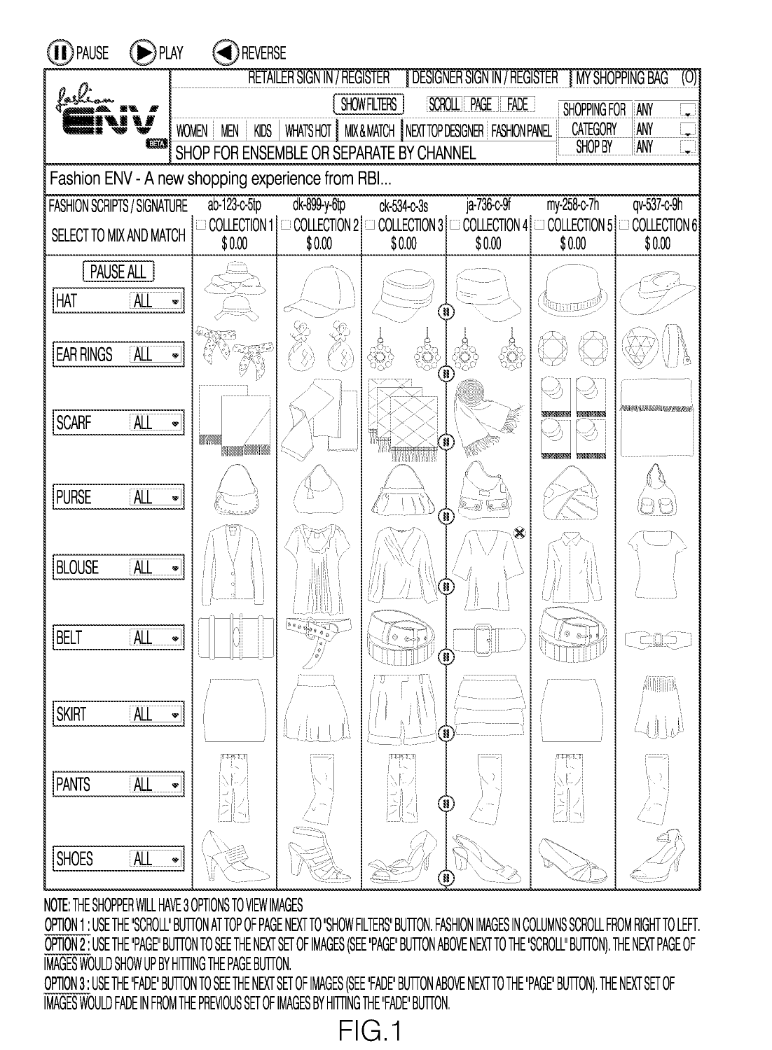

Referring now to FIG. 1, a default scrolling setting is shown on an online shopping screen. This shopping screen may be used as a stand-alone shopping tool, allowing a user to scroll through various combinations of fashion items. In some embodiments, the shopping tool of the present invention may be used by another store or vendor to display their items to a shopper. In the embodiment of FIG. 1, there are six silos (columns), and nine channels. Typically, the channels may be arranged to provide head to toe fashion choices. For example, the first channel may be head wear, such as hats, the second channel may be for ear rings, the third channel for scarfs, the fourth channel for purses, the fifth channel for blouses, the sixth channel for belts, the seventh channel for skirts, the eighth channel for pants and the ninth channel for shoes, for example.

A user may select individual items. After at least one item is clicked, a check box at the top of the silo turns on (vs. when the box is inactive it is greyed out) indicating the shopper is in compare mode or can go to checkout. Selected items may be placed into a comparison screw view/database or into a shopping cart, for example.

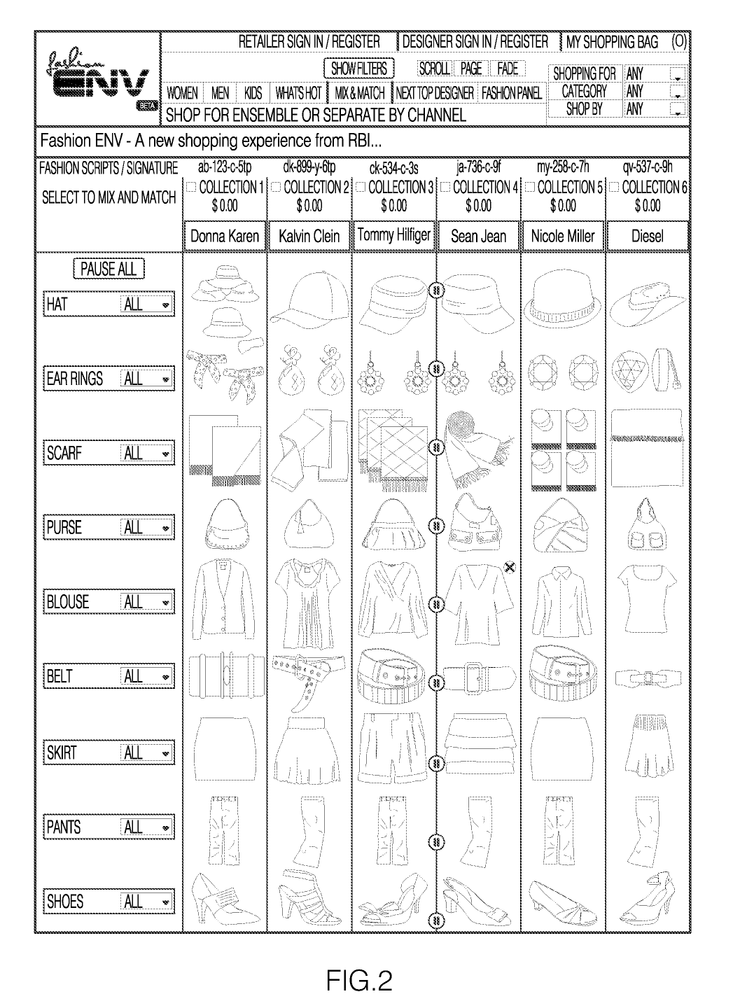

Referring to FIG. 2, each silo may be limited to a particular designer. This may permit the user to see ensembles of a single designer in a particular silo, but may also allow the user to see how a hat by one designer may look with a blouse from another designer (in a different silo, but still on the same screen). The particular designers for each silo may be set by the user or, in some embodiments, may be set by a site administrator. Each silo may be a different designer, as shown in FIG. 2, or one designer may appear in more than one silo. For example, if a user wishes to shop for only two designers, the user may set up the first three silos for one designer and the next three silos for another designer. In this configuration, one set of designs may scroll through the first three silos, while another set of designs may scroll through the last three silos, for example.

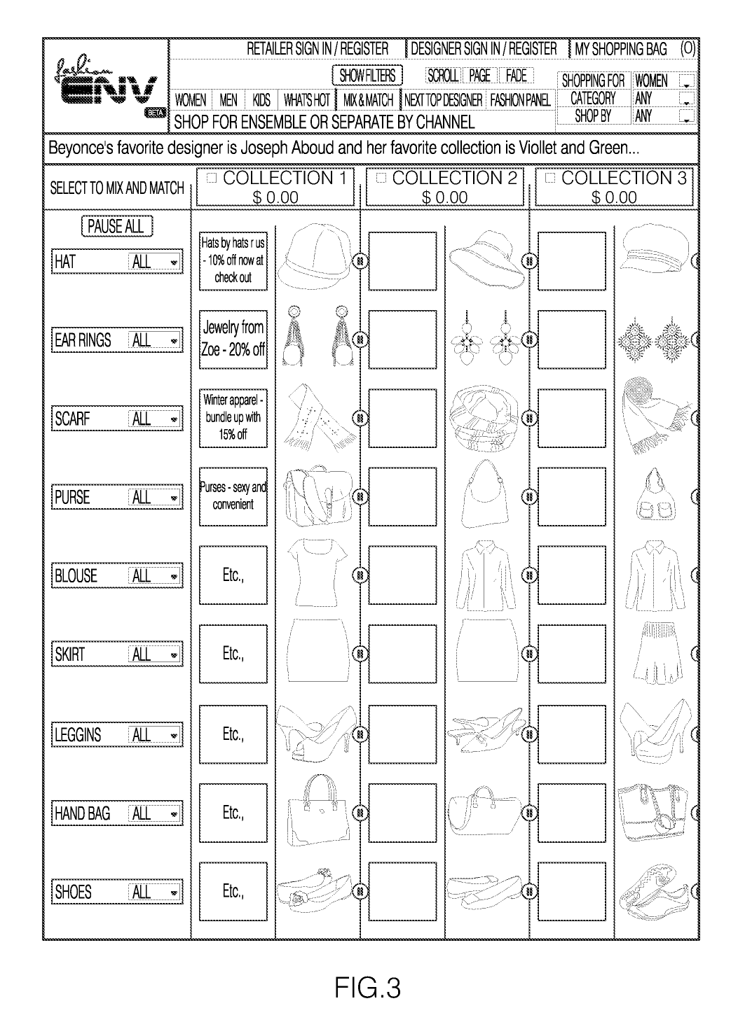

Referring to FIG. 3, one or more silos may, instead of showing fashion options, show item description or various advertising. For example, if a particular designer is on sale, the silo may indicate such a sale next to the item. In some embodiments, an item description/advertising silo may be displayed next to each fashion image silo, as shown in FIG. 3.

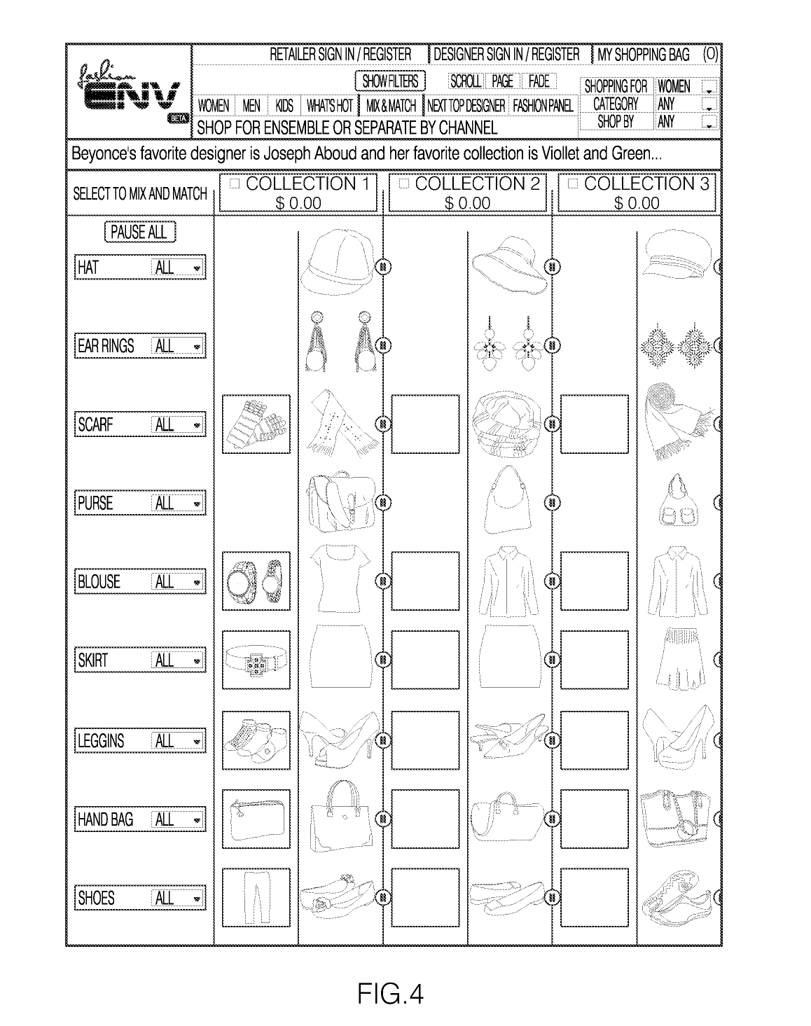

Referring to FIG. 4, one or more silos may, instead of showing fashion options, show various accessory silos. For example, in the scarf row/channel, next to a scarf in the fashion silo, glove options may appear in the accessory silo. Or, in the shoe row/channel, next to a pair of shoes in the fashion silo, sock options may appear in the accessory silo.

Referring to FIG. 5, one or more of the silos may be a gift buying view silo. In this view, a user may select another registered user to shop for items on their wishlist. A user may also configure their wishlist by, for example, selecting their own name in the gift buying view silo and selecting the items from the various fashion silos also displayed on the screen. The gift buyer may be able to see what others have purchased (for example, in other channels), where the shopper may purchase items on the user's wishlist to complete a certain ensemble.

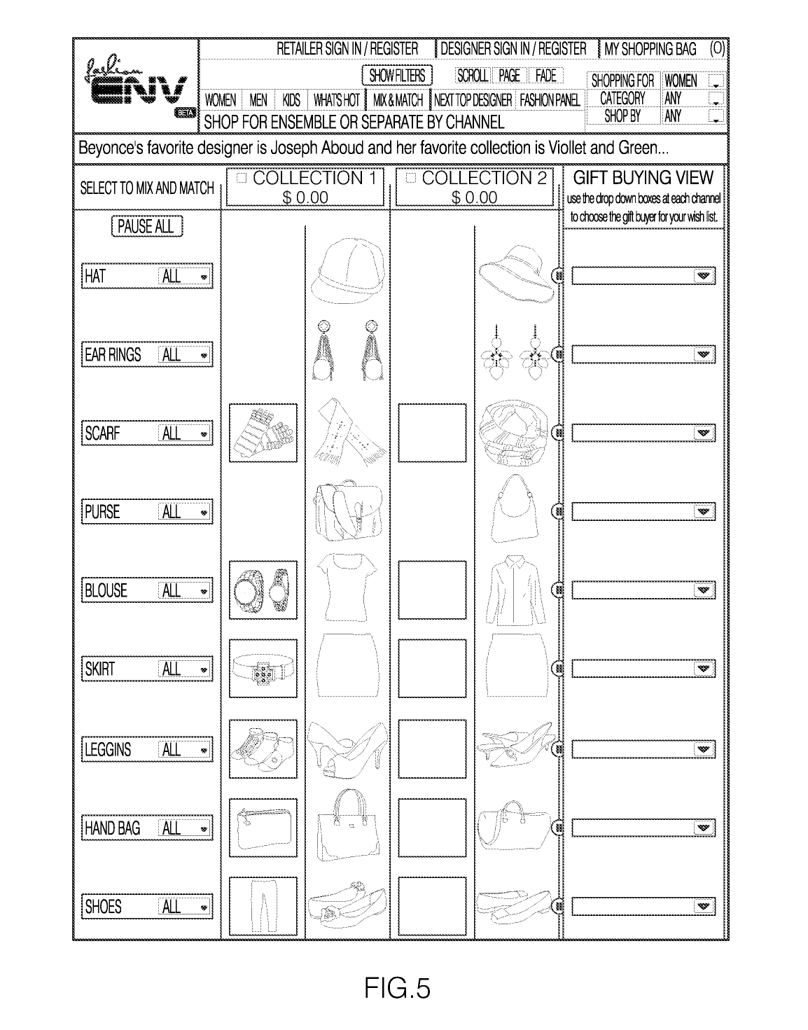

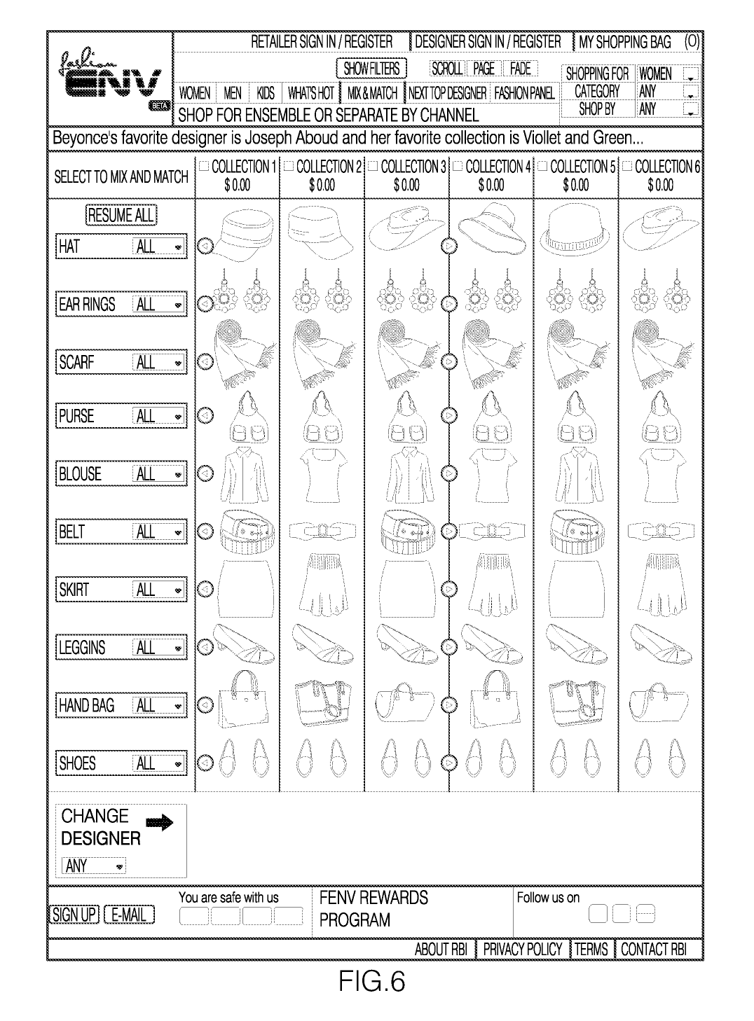

Referring to FIG. 6, the scrolling mix and match screen may include freeze and reverse controls. The freeze control, as described above, may be used to freeze a row, column, item or the entire screen. The reverse buttons may reverse a row by one image at a time. This option may allow a user to see an image that may have just scrolled off the screen, without having to wait for that item to cycle through again; the shopper can then click that item to select it. The screen may also include a change designer button, which may allow a user to select one or more designers to include on the mix and match screen.

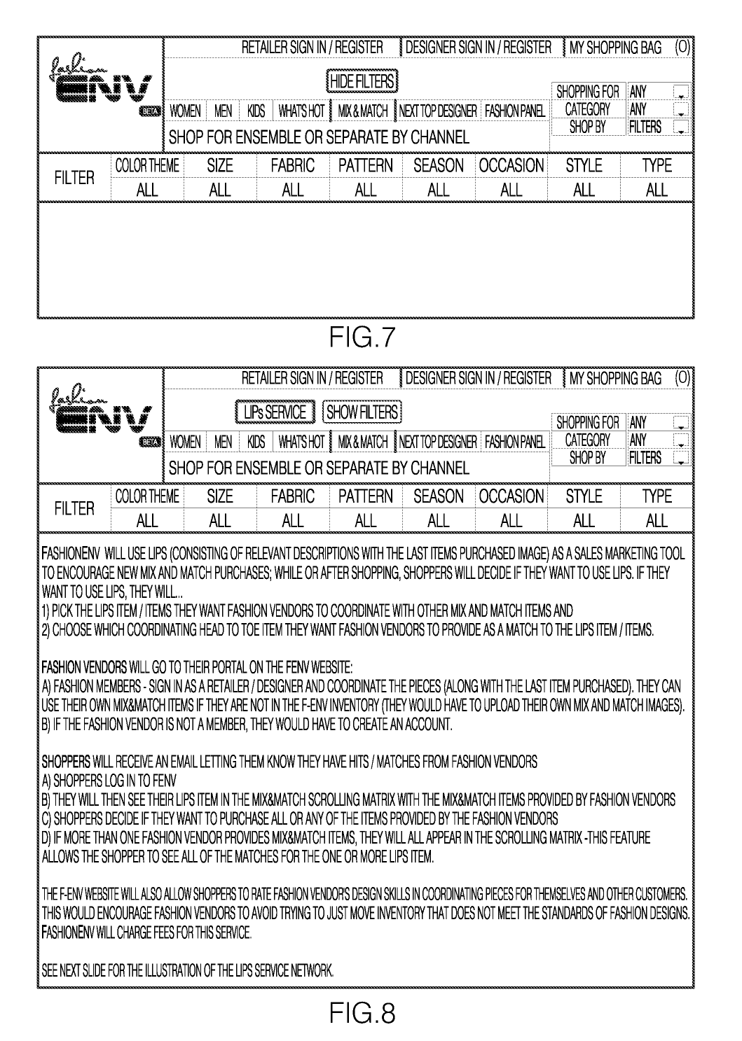

Referring to FIG. 7, a filter screen is shown. The filter screen may include various options where a user can customize their experience by showing, for example, only certain colors, fabrics, sizes, designers, or the like.

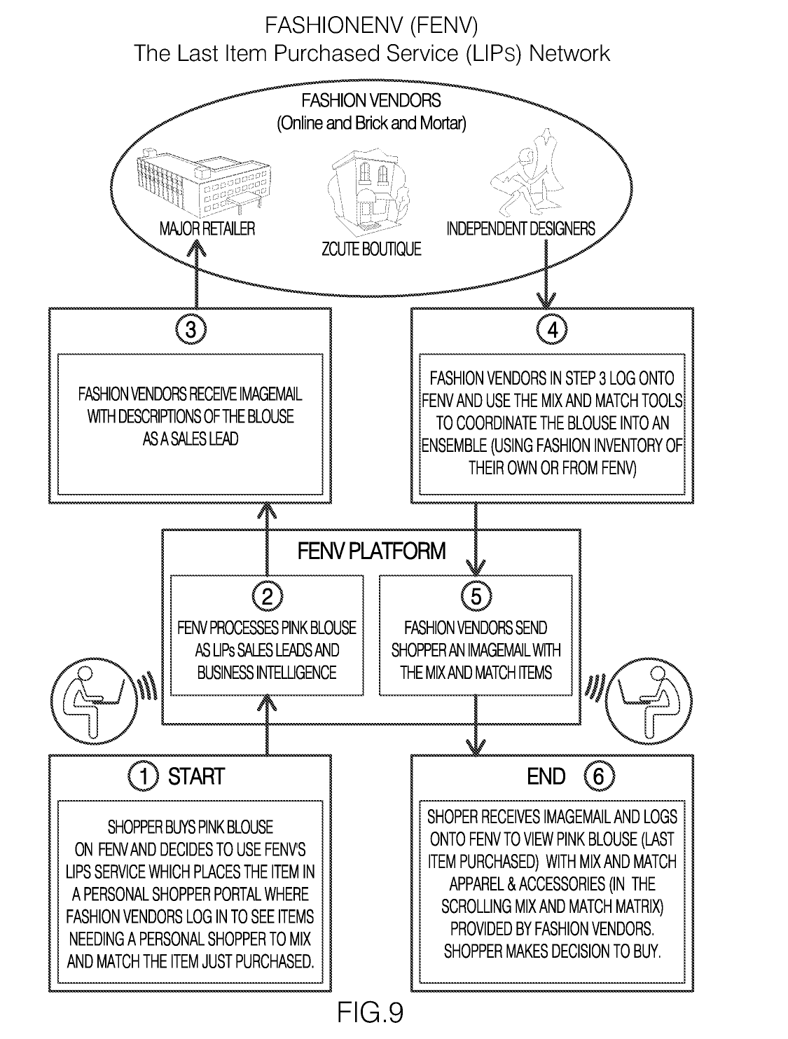

Referring to FIGS. 8 and 9, a last items purchased service (LIPS) may be included with the system of the present invention. This service may be used as a sales lead marketing tool to encourage new mix and match purchases. LIPs can be sent to other fashion vendors to offer potential mix and match fashion items to customers. Fashion vendors who have coordinated potential mix and match apparel/accessories with the customer's last item purchased can then go to the website of the present invention to, for example coordinate various pieces together or add mix and match items to the inventory as needed. LIPs can also include items that the shopper clicked on (commonly known as impressions in online advertising) but did not purchase. In addition, LIPS could include pictures of fashion items from a shoppers personal closet at home that he or she want to have fashion vendors mix and match.

The website of the present invention may also allow shoppers to rate their fashion vendor's design skills in coordinating pieces for themselves and for their customers. This would encourage fashion vendors to avoid trying to move/promote inventory that does not meet the standards of basic fashion mix and match design. A fee may be charged for the LIPs service.

For example, as shown in FIG. 9, if a user purchases a pink blouse, the system of the present invention may process the pink blouse as LIPs sales leads and send fashion vendors a message with descriptions and a image of the blouse as a sales leads. The fashion vendor's may sign into the system of the present invention, using the mix and match tools, to coordinate the blouse into an ensemble using their own apparel. The fashion vendors may send a message to the shopper with the mix and match items and the shopper may sign in to view the recommended mix and match apparel and accessories that could be displayed in the mix and match scrolling matrix; the coordinating items uploaded by the fashion vendor will be highlighted by a flashing symbol or some other mechanism to indicate to the shopper which mix and match item in the scrolling mix and match matrix was provided by the fashion vendor via the LIPS service.

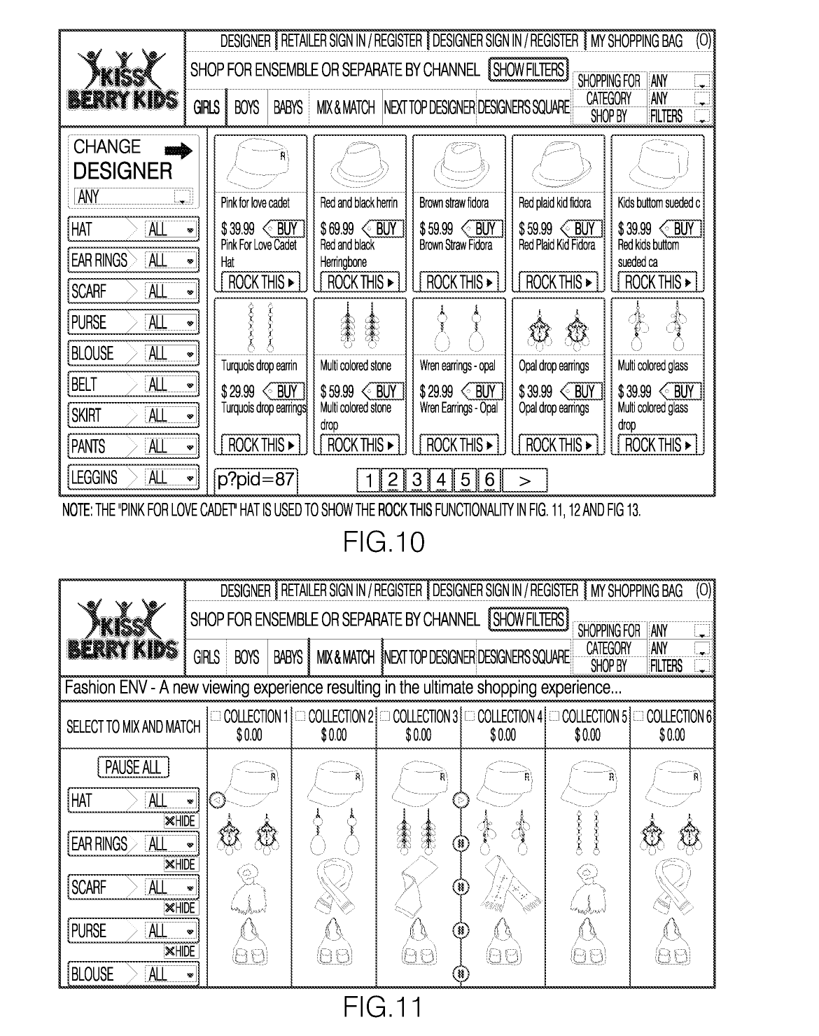

Referring to FIGS. 10 and 11, a “Rock This” button may be included with the system of the present invention. The site can use the “Rock This” button to coordinate individual items that appear on the girls, boys and babies, women and men tabs (see button on FIG. 10). Activating the button by pressing it will display the image/apparel item in the scrolling mix and match matrix tab in the corresponding category row/channel, allowing the shopper to see how that apparel/accessory item looks with other parts of an ensemble. FIG. 10 is typical of sites that appear in most websites which include fixed images on a static shopping screen.

On the mix and match page, the item being shopped for will be frozen on the appropriate row/channel in each of the one or more columns/silos while the items in all of the other channels scroll across the screen. See FIG. 11, for example. In this option for the “Rock This” button, the shopper can hide fashion categories on each row/channel that they are not interested in shopping for.

The button could be labeled MIX&MATCH IT or ROCK THIS or STYLE THIS, or the like. Computer code may be provided to fashion vendors that would place the “Rock This” button under each image on their website. The fashion vendors could also get the scrolling mix and match matrix to get the full functionality.

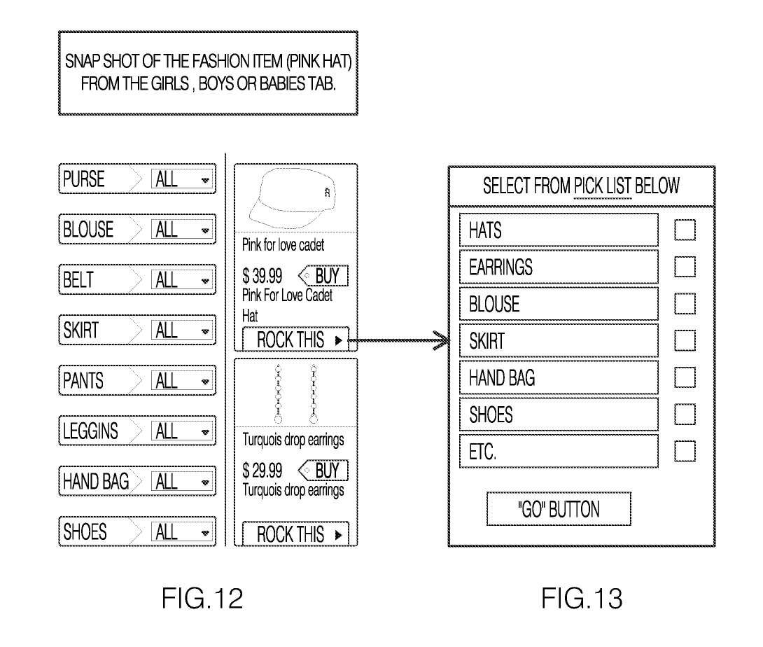

Referring to FIGS. 12 and 13, in another aspect of the present invention, the “Rock This” button is shown with a Pink Hat that the shopper is shopping for (FIG. 12) and, as shown in FIG. 13, a Pick List may appear when the “Rock This” button is pressed in FIG. 12. In this option, FIGS. 12 and 13 shows the “Rock This” button, whereby clicking it once displays a pick list (or drop down box or check box, or the like) to allow the shopper to select, on the same page, which fashion categories from head to toe he/she wants to coordinate with the main image (the “Pink Hat”); these selections along with the pink hat will be displayed in the scrolling mix and match matrix page. This option is different from FIGS. 10 & 11 because the shopper is choosing which other head to toe (Hat, earring, blouse, belt, skirt, etc.,) fashion categories/items can be coordinated/Rocked with the pink hat. The shopper can choose the coordinating items by checking boxes or highlighting each selection with the control key or some other method to select the categories desired. After selections are made, the shopper will then hit the GO button (FIG. 13) at the bottom of the pick list and then the Rock This “Pink Hat” and the other fashion categories selected from the pick list or drop down box will be displayed in the scrolling mix and match matrix page. The scrolling mix and match matrix will display the item being shopped for (“Pink Hat”) in a freeze mode and all of the other items from the pick list will scroll across the screen to facilitate mix and match shopping. Fashion categories not selected on the pick list will not be displayed in the scrolling mix and match matrix. The pick list may also show coordinating colors, styles, fabrics, etc., to choose from. Or the shopper can set the filters on the Mix and Match tab.

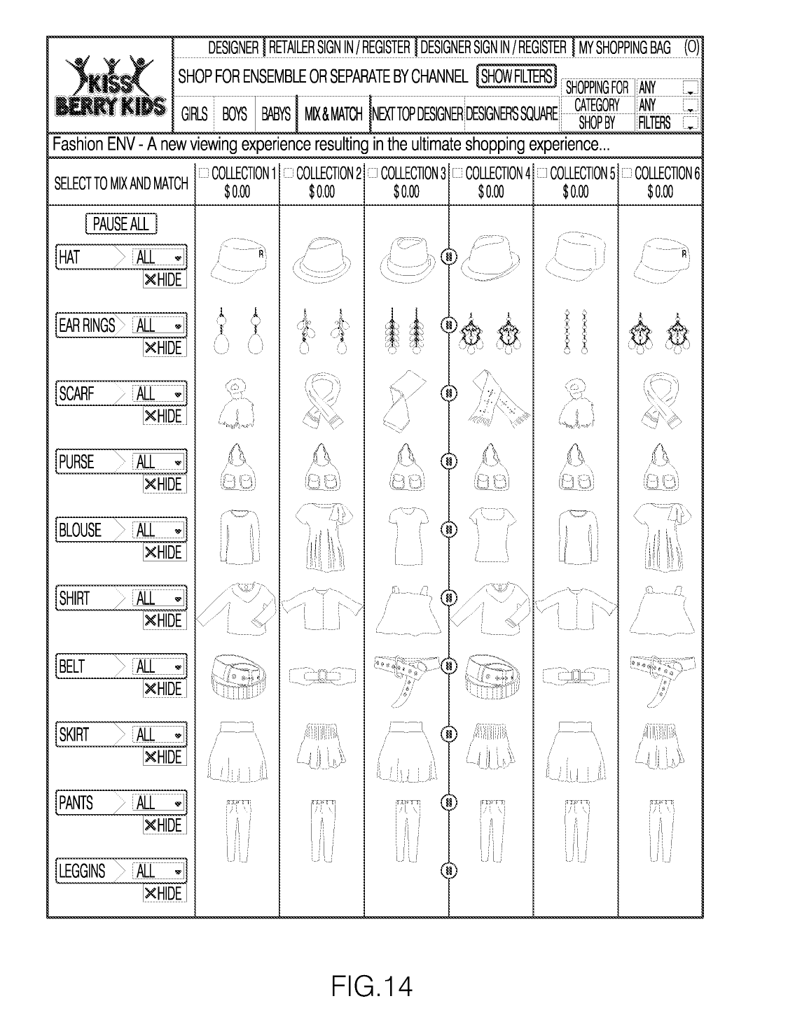

Referring to FIG. 14, “Hide” buttons allow the shopper to hide category channels to narrow the search for mix and match items. As an example, the shopper may not want to shop for a scarf, so the shopper will have the option to hide this row/channel and others if necessary. The hidden rows will also have functionality to unhide all hidden rows (or “view all channels”).

The home page of the present invention may have a tab labeled Mix and Match. After clicking the mix and match tab, it will take the shopper to a shopping page where the shopper can use the shopping tools to select preferences and the result will be fashion images that scroll across the screen, displaying fashion items that make up a complete ensemble from head to toe. The present invention provides a new way to shop apparel by a new concept called Multi-channel Scrolling Matrix. Channels scroll together or independently across silos allowing the shopper to shop by ensemble or by piece. Shoppers will shop by advanced filters (located in the “Shop By” drop down box in upper right hand corner on the mix and match page, for example) based on their desired taste (color/color combinations, fabric, pattern, occasion, style, size, season, LIPs, etc.,) and then select which fashion vendor and their respective brands and items they want to shop by. Shoppers will shop by the same or by multiple fashion vendors/brands. The filter selection tool in the upper right hand corner can also be located anywhere on the mix and match page since it is a key tool that enhances the shopping experience and helps the shopper narrow the search for the apparel/accessory item or items that they are looking for.

The shopping tools of the present invention could also be licensed to fashion vendors, and the like. Licensees can customize their own matrix from 1 to 6 or more silos that intersect with 1 or more channels. With this product image solution of the present invention, shoppers can use advanced filters, multichannel shopping by fashion vendor and scroll, click, freeze and roll tools to build a complete ensemble which can then be sent to the dressing room for the purchase decision. Shoppers will be immersed in a new viewing experience resulting in the ultimate shopping experience; they will watch and shop their selections (retrieved from the admin database) scrolling across the screen. With the freeze tools, the shopper can freeze one or more items individually or freeze all items collectively (with one click on the “freeze all” or some similar button). Also, each ensemble created can generate its own unique fashion script signature (similar to an SKU #) for that shopper. This fashion script signature can be used on the order form at checkout and for tracking and data mining/marketing purposes and can be used to build a Fashion DNA/Fashion Genome Project database (based on customer's profile/fashion taste) to be used for further data mining/business intelligence/marketing purposes.

The fashion scripts can include of a series of alpha and numeric characters that represent codes for type of item or items (e.g., dress, blouse, shoes, jewelry, etc.), color, fabric, pattern, season, style, size, occasion, vendor, shopper ID, and the like. The fashion scripts can appear at the top or bottom of each silo. It is important to note that the fashion script can have multiple codes consisting of one code for each item such as hat, jewelry, blouse, belt, pants, etc., one code for color, one code for designer, etc.; when the codes are grouped together, the result would be a fashion script for each ensemble.

The present invention may also include image layering. For example, if a user selects a particular scarf and blouse, an option may then appear to view an layered image, showing the scarf as if it is wrapped around the selected blouse, or how a neck tie coordinates on top of a dress shirt, for example.

The present invention may also be used as a platform to create a search site for fashion that is similar to Google's search engine for information but instead dedicated to design and fashion. The shopper would type in the search box, the fashion item being searched and set filters and the head to toe results would appear in a scrolling mix and match matrix.

The present invention may also display a fixed/static (e.g., images do not scroll across the screen) mix and match page with images in their present fixed location at row and column intersection points on a fixed or static screen that fade in and out or loop from one image to the next (e.g., all hats will cycle through just one single image box for hats in a time loop). This option will also allow the user to watch and shop all images in inventory.

The user may have various controls and options for the website. For example the user may control the scroll speed of each channel, may select preferred designers, may select the number of silos, may hide one or more channels (e.g., the shopper may not be interested in hats so this channel can be hidden), and the like.

The present invention may include software, residing on a computer readable media that may control the various functionalities described above. The software may be stand-alone software that, for example, may be used in a kiosk at a brick and mortar store. In some embodiments, the software may reside on a computer to operate a website that users may access. Multiple users may be capable of accessing the website at one time. The software may be used by individual users to help inventory their clothing and help users manage what to wear and what to buy based on the shopper's own closet.

In some embodiments, the software may include a dressing room, where users may upload their own picture and the software may show selected items superimposed on the user's picture. This may help a user to choose items or ensembles that may accent the user's skin tone, eye color, or the like.

The present invention may not only be used for fashion ensembles, but may also be used in other areas where selection of various options may be needed. For example, the present invention may be used in the furniture industry to help users shop for furniture, accent tables, and décor.

It should be understood, of course, that the foregoing relates to exemplary embodiments of the invention and that modifications may be made without departing from the spirit and scope of the invention as set forth in the following claims.

What is claimed is:

1. A computer software product disposed on computer readable media and having computer code adapted to perform the steps of:
providing a matrix of a plurality of columns and rows on a screen;
providing images of grouped fashion items across each row;
scrolling each row independently to allow the images of grouped fashion items to appear on the screen; and
providing a means for freezing at least one of an entire screen, an entire row, or an individual image in the matrix.

2. The computer software of claim 1, further comprising computer code adapted to perform the step of displaying a particular designer in each column.

3. The computer software of claim 1, further comprising computer code adapted to perform the step of displaying an item description or an advertisement in a column adjacent to the images.

4. The computer software of claim 1, further comprising computer code adapted to perform the step of displaying an accessory in a column adjacent to the images.

5. The computer software of claim 1, further comprising computer code adapted to store a user wishlist in a database accessible to another user desiring to make a purchase for the user from the user wishlist.

6. The computer software of claim 1, further comprising computer code adapted to provide a last items purchased service (LIPS), wherein the LIPs service provides the user with other fashion images from various fashion vendors to create ensembles based on prior purchases.

7. The computer software of claim 1, further comprising computer code adapted to mix and match fixed images in their present location at row and column intersection points on a fixed mix and match matrix screen where each image fade in and out or loop from one image to the next, wherein the mix and match matrix screen is fixed and does not scroll across the screen.

8. A website having a mix and match screen display, the mix and match screen display comprising:
a plurality of columns and a plurality of rows;
a plurality of images disposed at intersections of the plurality of columns and the plurality of rows, wherein the images scroll across the screen display; and
one or more selection buttons, wherein the selection buttons are adapted to hide or unhide an entire row, freeze or select a single image, an entire row, an entire column, or the entire screen, wherein
each row includes images of related fashion items, and
each column provides a head to toe fashion ensemble.

9. The website of claim 8, further comprising a filter selection screen adapted to allow a user to filter the plurality of images displayed based on one or more predetermined factors.

10. The website of claim 9, further comprising a dressing room screen adapted to display a selected head to toe ensemble to the user.

11. The website of claim 10, further comprising a last item purchased service, wherein the user receives recommended ensembles based on prior purchases.

12. The website of claim 11, further comprising a “Rock This” button, wherein the user can click the “Rock This” button to initiate functionality that displays and freezes the fashion item being shopped across all silos/columns for the respective row, allowing the shopper to watch and shop all other items scrolling across the screen display.

13. The website of claim 12, wherein clicking the “Rock This” button generates a pick list/drop down menu on the display screen, adjacent to an item being shopped, wherein the pick list allows the user to choose other fashion categories that the user is interested in, wherein the website further comprises a “GO” button, wherein, after pressing the “GO” button at the bottom of the pick list, the user is taken to a Mix and Match page to view the items in a scrolling mix and match matrix, wherein only the item being shopped for will be frozen.
